(19) United States
(12) Patent Application Publication
(10) Pub. No.: US 2002/0152470 A1
(43) Pub. Date: Oct. 17, 2002

(54) Method and system for providing audio, video and data to devices on an aircraft

(76) Inventor: Mark Hammond, Laguna Niguel, CA (US)

Correspondence Address: Albin H. Gess, Price and Gess, Suite 250, 2100 S.E. Main Street, Irvine, CA, 92614-6238, US

(21) Appl. No.: 09/798,491

(22) Filed: Mar. 2, 2001

(51) Int. Cl. H04N 7/18

(52) U.S. Cl. 725/76; 725/74

(57) ABSTRACT

A method in a system having an antenna for tracking and transceiving intelligence bearing signals from/to satellites for use by a multiplicity of devices on an aircraft, and for automatically switching between different satellites while the aircraft is in route. The method includes the steps of retrieving navigational data from systems of the aircraft for use in determining the time and position of the aircraft. The method also determines if a service region of a first satellite is in transition, and if so; it determines if the satellite service overlaps with a second satellite and if the second satellite signal is stronger. If yes, then service from the second satellite is acquired by pointing the antenna to this second satellite and configuring second intelligence signals received from the second satellite. Then, the second intelligence bearing signals are displayed and distributed to devices within the aircraft.

### BACKGROUND OF THE INVENTION

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

1. Field of the Invention

The present invention relates to a method and system used in an aircraft for tracking and transceiving audio, video and data signals from/to satellites for a multiplicity of devices on the aircraft, and for automatically switching between different satellites while the aircraft is in route.

2. Description of Related Art

Several different types of systems are available for distributing audio and video signals to passengers on airlines, which signals are received from satellites while the aircraft is in motion. One such example is disclosed in U.S. Pat. No. 5,760,819, entitled Distribution of a Large Number of Live Television Programs to Individual Passengers in an Aircraft. The system disclosed in this patent provides distribution of live television programming within an aircraft to each passenger seat, where each passenger may individually select from many channels. This patent only focuses on one satellite or series of satellites broadcasting over a single geographical service area, such as the USA.

Another prior art system is disclosed in U.S. Pat. No. 5,790,175 entitled Aircraft Satellite Television System for Distributing Television Programming Derived from Direct Broadcast Satellites. The system disclosed in this patent includes an antenna disposed on the aircraft, which is pointed at a plurality of satellites that are part of a direct broadcast satellite system. The antenna is controlled by an antenna controller and antenna interface unit that send control signals and process status signals to steer the antenna. The antenna is steered so that it is locked onto RF signals transmitted by the satellite. The video signals for the multiplicity of channels are converted and decoded and routed to a video and audio distribution system on the aircraft, which distributes live television programming to the passengers. This patent, like the one above, only focuses on one satellite or series of satellites broadcasting over a single geographical service area, such as the USA.

Yet another prior art system is disclosed in U.S. Pat. No. 5,801,751 entitled Distribution of Satellite Television Programs to Passengers in an Aircraft when it is out of Range of the Satellites. The system disclosed in this patent is very similar in construction to those described above. The passengers are provided with live television programming when the aircraft is in the coverage area of the satellite, and time-delayed television programming during that portion of the flight when the aircraft is out of the coverage area of the satellites. In other words, this system provides for a system wherein time delayed television programming (typically on the order of one to several hours) is provided to the passengers. This patent, like those above, only focuses on one satellite or series of satellites broadcasting over a single geographical area, such as the USA.

Still another prior art system is disclosed in U.S. Pat. No. 5,929,895 entitled Low Cost Hybrid Video Distribution System for Aircraft In Flight Entertainment Systems. This patent teaches a system wherein a single tuner serves a group of seats. For example, one tuner may service up to 48 seats. All channels are provided from this tuner to each of the 48 seats so that a passenger may select a desired channel. This patent, like those above, only focuses on one satellite or series of satellites broadcasting over a single geographical area, such as the USA.

Therefore, a need exists for a method and system that has the capability of transceiving intelligence-based signals to/from a multiplicity of devices on a moving aircraft and that can track a large variety of satellites and automatically switch from one to another as the aircraft progresses across international boundaries (as well as regulatory boundaries) on the earth.

### SUMMARY OF THE INVENTION

Accordingly, it is an object of the present invention to provide an improved method and system for distributing live television broadcasts to a multiplicity of seats on an aircraft while in flight and moving across international boundaries.

Another object of the present invention is to provide a system with capabilities of automatically switching from one satellite geographic coverage service area to another while an aircraft is in route.

Yet another object of the present invention is to provide a system that employs on-board data to automatically track a satellite in accordance with data in a database storing geographic coverage service areas available along the route of the aircraft.

Another object of this invention is to provide “roaming” operations that receive or transmit audio, video and data transmissions by air-mobile users on a global basis.

Still another object of this invention is to provide for an on-board transception system that can be applied to any geo-synchronous satellite or satellite service area.

Yet another object of this invention is to provide a “situationally aware” system that can make decisions without operator intervention.

A feature of the present invention resides in the provision of a system that addresses regulatory issues concerning reception within and across international borders.

Another feature of the present invention resides in the provision of communication with audio, video and data distribution networks for the purpose of notifying the passenger of the system state.

Yet another feature of the present invention is the provision of touch-screen controls for use by passengers in communicating with the system.

An advantage of the present invention is the application of the satellite service EPG to identify the desired satellite audio, video or data program material.

Another advantage of the present invention is the application of event triggers to automatically record program material off the satellite audio, video, and data signals, and to synchronize the playback thereof using the time base down-loaded from the satellite.

These and other objects, which will become apparent as the invention is described in detail below, are provided by a method in a system having an antenna for tracking and transceiving intelligence bearing signals from/to satellites for use by a multiplicity of devices on an aircraft, and for automatically switching between different satellites while the aircraft is in route. The method includes the steps of retrieving navigational data from systems of the aircraft for use in determining the time and position of the aircraft. The method also determines if a service region of a first satellite is in transition, and if so; it determines if the satellite service overlaps with a second satellite and if the second satellite signal is stronger. If yes, then service from the second satellite is acquired by pointing the antenna to this second satellite and configuring second intelligence signals received from the second satellite. Then, the second intelligence bearing signals are displayed and distributed to devices within the aircraft. The system includes a unit responsive to the aircraft navigational data for determining the right to transceive the intelligence bearing signals within various geographical regions by applying regulatory criteria from a database containing such information.

Still other objects, features and advantages of the present invention will become readily apparent to those skilled in the art from the following detailed description, wherein is shown and described only the preferred embodiment of the invention, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive, and what is intended to be protected by Letters Patent is set forth in the appended claims. The present invention will become apparent when taken in conjunction with the following description and attached drawings, wherein like characters indicate like parts, and which drawings form a part of this application.

### BRIEF DESCRIPTION OF THE DRAWINGS

The general purpose of this invention, as well as a preferred mode of use, its objects and advantages will best be understood by reference to the following detailed description of an illustrative embodiment with reference to the accompanying drawings in which like reference numerals designate like parts throughout the figures thereof, and wherein:

FIG. 1 illustrates a perspective view of an aircraft flying across an international border while receiving audio/video/data signals from satellites;

FIG. 2 is an overall block diagram of the system of the present invention;

FIG. 3 is an image for display to passengers on an aircraft showing the relationship of the aircraft with points on the ground and for time of receipt of upcoming television broadcast coverage;

FIGS. 4A and 4B combined are a flow chart of the Initialization process of the present invention;

FIGS. 5A and 5B combined are a flow chart of the In-Route process of the present invention; and

FIGS. 6A and 6B combined are a flow chart of the Synchronization Operations process of the present invention.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide a method and system for use in a moving aircraft which tracks and receives or transmits (hereafter “transceives”) audio, video and data signals from/to satellites, and distributes the same to a multiplicity of devices on the aircraft, and for automatically switching between satellites while the aircraft is in route.

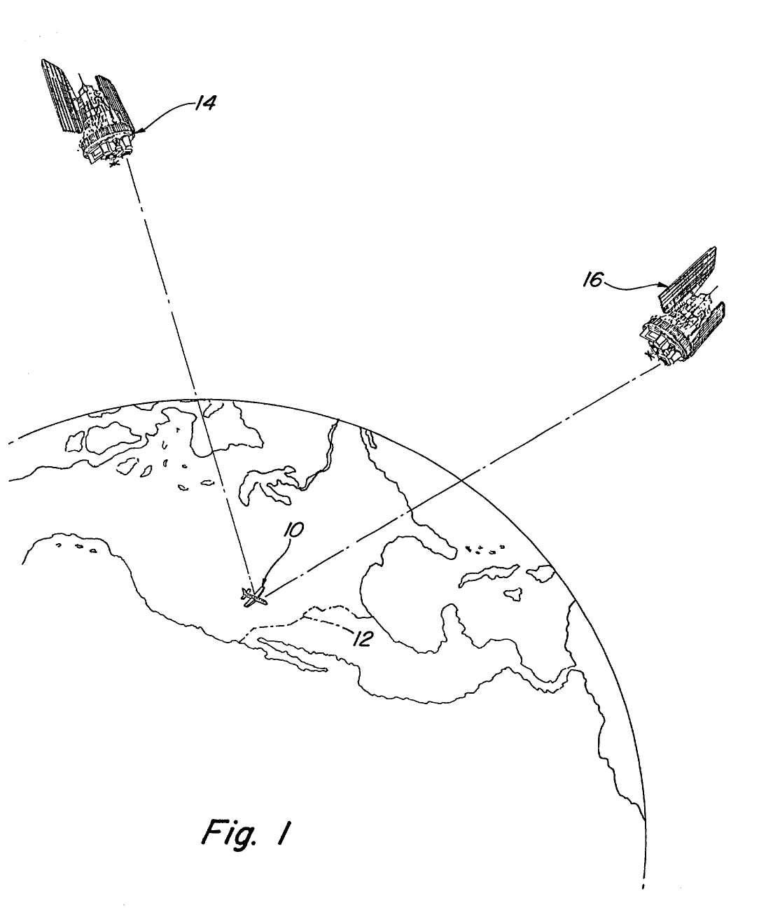

Referring now to the drawings and to FIG. 1 in particular, an aircraft 10 is shown in route as it moves across the US/Mexico border 12. As illustrated, the aircraft is transceiving audio, video and data RF signals from/to a first satellite 14, which covers the geographical service area of the United States. Satellite 14 may for example comprise the DBS 1/2/3 constellation transmitting television signals provided by DirectTV. As the aircraft 10 moves further across the border 12, it enters the geographical service area of a second satellite 16, which may comprise Galaxy 8-i broadcasting DirecTV Latin America. As will be explained in greater detail hereinbelow, the present invention automatically switches to the satellite 16 after crossing the Mexican border.

By using the situational awareness module on board the aircraft, the present invention is able to automatically switch and track different satellites without any user intervention. This module exhibits “situational awareness” during normal operations of the aircraft anywhere in the world. Situational awareness is derived by this module from aircraft navigational data processing and from configuration data of the aircraft on-board services.

In general, Aircraft Navigational Data (hereafter “NAV”) is obtained from the navigation computer (inertial reference systems and flight management systems) found on board every aircraft. The system of the present invention “snoops” on the NAV data bus of the aircraft, reading and processing the navigational message “labels”, which provide all of the relevant aircraft attitude and location information—including aircraft latitude, longitude, altitude, heading, pitch angle and roll angle. With this information, the NAV determines where-in-the-world the aircraft is located and what it needs to know to dynamically steer (point and control) the antenna on the aircraft.

Upon power-up, the system communicates internally between its constituent units, using a data bus protocol. From this internal communication, the Satellite TV Software Module (“STV”) derives its knowledge of which satellite services are supported by physical hardware on board the aircraft. A number of databases are stored within the system and are utilized by the STV for decision making. These databases include Satellite Service Acquisition Parameters, such as:

a. New satellite location (geo-synchronous longitude on the equator);

b. Down Converter Local Oscillator-Frequencies (“tuning” to the satellite frequencies);

c. Database of expected satellite transponder frequencies with transceiver parameters (symbol rate, FEC, band selects and polarity);

d. Polarization Converter settings for Frequency Band Select, Linear vs. Circular Polarity selection, Polarization Angle Offset, and Satellite Meridian Offset;

e. RDU selection includes the specific transceivers and the Conditional Access (“CA”) SmartCard to be used; and,

f. The right to transceive audio/video/data from satellites over a given region or “service landing rights”, which is defined as the right of a sovereign government to control the transception of signals (satellite based or otherwise) over that country's geographical territory, its territorial waters and its airspace.

### Automatic Behavior Upon Initialization

The STV follows a few basic rules that govern its behavior. First, there is the automatic behavior upon initialization. That is, upon initialization the STV checks the NAV information in order to determine if the aircraft currently resides within the geographic coverage area of any satellite service. If a match is found the STV automatically implements acquisition of the valid service. If multiple matches are found (e.g., DirecTV and Dish Network services in the Continental United States, i.e., “CONUS”) the STV chooses one service based on priorities previously established for the user (in a System defaults database) and automatically implements that choice. The STV also chooses the channel/program selections based on the last channel settings or defaults established for the user. In this manner, the STV has the ability to provide virtually “seamless” switching from one satellite service area to the next.

For example, a user is viewing CNN via DirecTV while flying over the United States. When the US/Canada border is crossed, the system automatically acquires the Bell-ExpressVU-Canada service and tunes to CNN once again. The user only notices a short delay while the system announces that it is “Searching for Satellite”.

The STV also supports manual selection of valid services within a service area should the user desire to make a choice on their own initiative. For example, with the aircraft outfitted with Receiver Decoder Units (“RDU”) for TPS-Europe and CanalPlus-Europe services, the user may manually select either service while the aircraft is located in the European region. Standard direct infra red remote control commands (channels selection, etc.) are also supported for general use with the RDU's.

### Automatic Behavior In-Route

While in-route, the STV constantly monitors the aircraft position information and determines if the aircraft resides within a valid geographic service coverage area. If the aircraft exits a service area the STV checks to determine if another adjacent, valid service is configured in the hardware. For example, at the US/Mexico border (see reference 12, FIG. 1), DirecTV-US and DirecTV Latin America services lie adjacent to one another, straddling the borderline. If an adjacent, valid service exists in the system, the STV automatically implements acquisition of this valid service.

While in-route, if the aircraft exits a service area and another adjacent service area is not configured, the STV will automatically “de-activate” the system and “park” the antenna. This could occur, for example, East of Nova Scotia, ExpressVu-Canada service is not available for aircraft flying due east. On the other hand, while in-route, if the aircraft enters a service area where a valid service exists, the STV will automatically implement acquisition of the valid service. This could occur, for example, while an aircraft is flying due west when located east of Nova Scotia where ExpressVu-Canada becomes available.

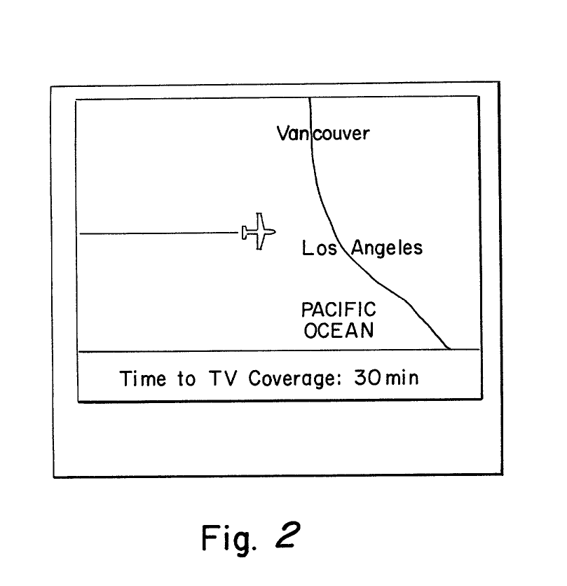

Referring now to FIG. 2, a Moving Map image is illustrated, which may be displayed on the individual passenger monitors. The STV communicates to the Moving Map system all of the relevant system information, allowing the display of live TV status to the passengers. Furthermore, integration and communication with the on-board audio/video/data system can provide for automatically displaying the Moving Map program on the cabin video monitor whenever the aircraft has left or entered a coverage area in order to serve as a notification. For example, as shown in FIG. 2, an aircraft 20 is shown approaching the coast of California. Additionally, a text message informs the passenger that they are approaching a coverage area and a calculation is made of the distance/time until the aircraft enters the area. This display capability is disclosed in U.S. Pat. Nos. 4,975,696 and 5,208,590. It should be understood that this particular illustration of an aircraft video display system is only set forth as an example of one of many such systems that may be utilized and therefore should not be considered as limiting the scope of the present invention.

Furthermore, the integration of these systems allows information programs, such as Airshow Network provided by the assignee hereof, to be substituted for the live TV programs on the cabin monitors, while the aircraft is located in a “no TV coverage” zone (such as over the North Atlantic).

Advanced features of the present invention provide for reading and understanding the satellite TV electronic program guides (EPG), which are broadcast by the respective satellite TV services. An example tabulation of Ku-band Regional Direct Broadcast Satellites (DBS) is shown in Table I below. The STV is capable of using this information to make decisions that allow it to synchronize program display for an airline In Flight Entertainment (IFE) applications.

TABLE I

| | | | | Digital |
|---|---|---|---|---|
| | | | | Broad- |
| Service | Service | | Conditional | cast |
| Region | Provider | GEO Satellites | Access | Format |
| Canada | ExpressVu | Nimiq 1 | Nagravision | DVB |
| China | TBD | AsiaSat 3S | TBD | DVB |
| CONUS | DIRECTV | DBS 1R/2/3 | NDS | DSS |
| CONUS | Dish Network | Echostar 119 W | Nagravision | DVB |
| Europe | TPS and D+ | HotBird 1-5 | Viaccess/ | DVB |
| | | | Irdeto | |
| Europe | Sky Digital | Astra 2A | Mediaguard | DVB |
| Europe | Canal Plus | Astra 1F/G/H | Mediaguard/ | DVB |
| | | | Viaccess | |
| Japan | Sky PerfecTV | JCSAT-3 | Multi-access | DVB |
| Japan | NHK | BSAT 1A/1B | Free-to-Air | DVB |
| India | TBD | Asiasat 3S | TBD | DVB |
| Latin | DIRECTV | Galaxy 8-i | NDS | DSS |
| America | Latin America | | | |
| SE Asia | Astro | Measat 1/2 | Mediaguard | DVB |
| Middle East | Showtime and | Nilesat | Irdeto | DVB |
| | ART | 101/102 | | |
| South | MultiChoice | Panamsat 4 | Irdeto | DVB |
| Africa | | | | |

Note: Table I is current as of Jan. 1, 2001, and subject to change based on satellite launches, satellite retirements, ITU governing regulations, etc.

The STV is capable of deriving from the EPG of TABLE I such information as program identifiers and program names, and satellite service (regional) master time base. Moreover, the STV can determine a start time for a program/event; it can communicate the program/event status to on-board equipment; it can synchronize program introductions, program “bookends” such as advertising, airline branding, data overlays (stock ticker, etc.), or other airline content. The STV can also subsequently create a suitable “production quality” audio/video/data program. Furthermore, the STV can make on-the-fly adjustments for displaying the program in the event of interruptions, deviation in flight schedule, unavailability of the satellite signal, etc. Back-up content, stored on-board in the other intelligent equipment, may be used to provide fill-in content, etc.

It is very common in airline applications for a single program or a set of fixed programs to be distributed throughout the cabin for viewing by the passengers. The programs are generally synchronized to the flight by the flight attendants. Using the EPG information of TABLE I, the STV can work automatically (hands-off for the flight attendants) and in conjunction with on-board “intelligent” equipment in order to produce a single airline program-on-the-fly. This approach allows a live TV program to be brought on board and “massaged” into a complete, produced airline program suitable for passengers viewing and up to airline standards.

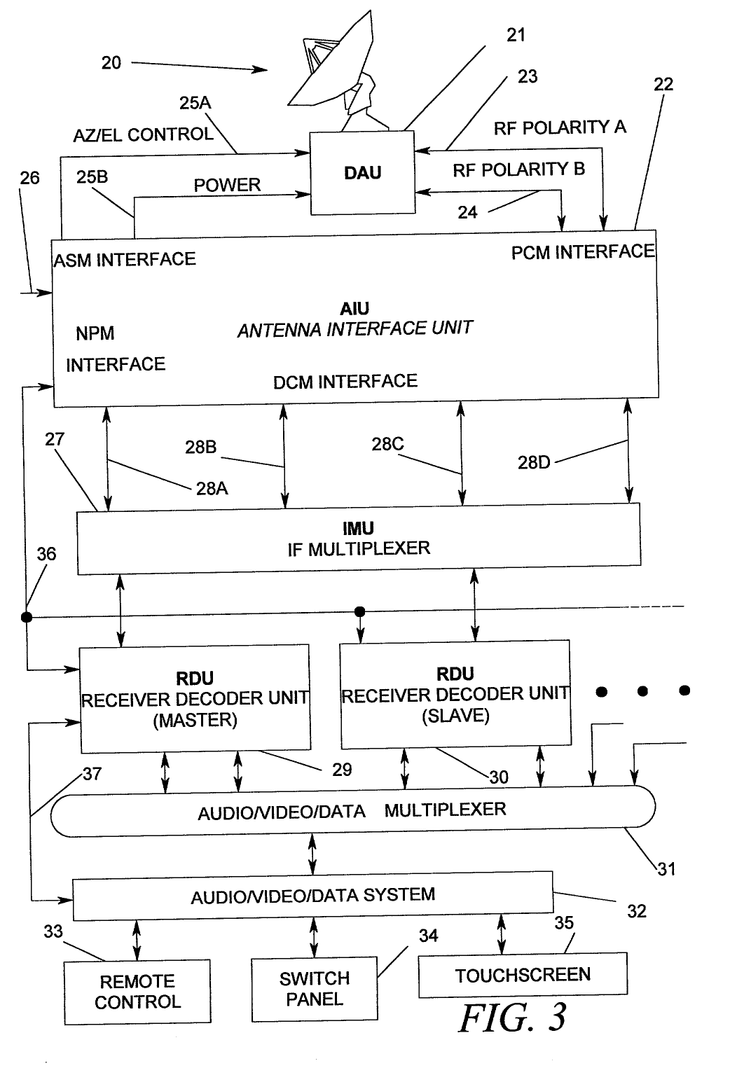

Referring now to FIG. 3, a block diagram of the system is shown. An antenna 20 is disposed on the aircraft and is movable so as to pick up satellite transmissions as the aircraft moves. A DBS (i.e., Direct Broadcast Satellite) Antenna Unit (“DAU”) 21 receives from the system (to be described shortly) signals for directing the antenna 20 and receives the transmissions from the satellite for use by the system. The antenna 20 may also be used for transmitting signals back to a central station via a satellite. An Antenna Interface Unit (“AIU”) 22 functions as the interface between the system, the aircraft and the DAU 21. The Antenna receives or transmits RF signals of both A and B polarity, which is split by the DAU 21 before being applied to the AIU 22 via lines 23 and 24, respectively. Power is supplied to the Antenna 20 and the DAU 21 from the AIU 22 by means of a line 25. Azimuth and elevation signals for the Antenna 20 are provided by the AIU, which signals are derived by navigational data signals from the aircraft on lines 26.

An IF Multiplexer (“IMU”) 27 receives or transmits the audio, video or data signals from the DCM Interface of the AIU 22 by means of lines 28A, 28B, 28C and 28D. The IMU buffers and multiplexes the audio/video/data signals for distribution to each of the system RDU's, such as a Master RDU 29 and a Slave RDU 30, supplying each with the requested frequency bands and polarities as required by the RDU audio/video/data programs. The Master RDU 29 performs an additional function of gathering navigational data signals from the aircraft via the AIU 22 and identifies valid service regions. That is, by accessing a database it performs a verification of the right to transceive audio/video/data from satellites over a given region. This is what is commonly referred to in the satellite business as “service landing rights”, which is defined as the right of a sovereign government to control the transception of signals (satellite based or otherwise) over that country's geographical territory, its territorial waters and its airspace.

The RDU's 29, 30 communicate with an Audio/Video/Data system 32 via an Audio/Video/Data multiplexer 31, which is used for switching or combining the various signals received or transmitted. A line 36 between the AIU 22 and the RDU's 29, 30 is used as a system communication bus. Specifically, it may be used for operation of the system as a stand-alone unit. A line 37 between the Audio/Video/Data system 32 and the Master RDU 29 is used for coupling the passenger channel selections to the RDU. The passenger remote control 33 or the touch-screen 35 is used for such selections. A switch panel 34 may also be used by the passengers or the crew.

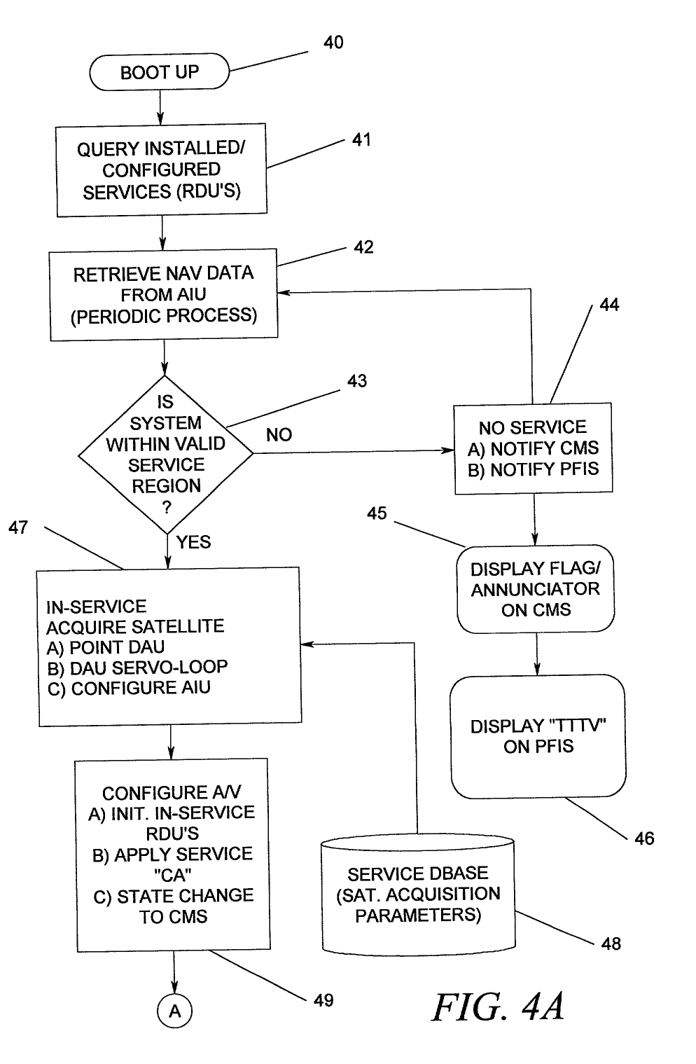

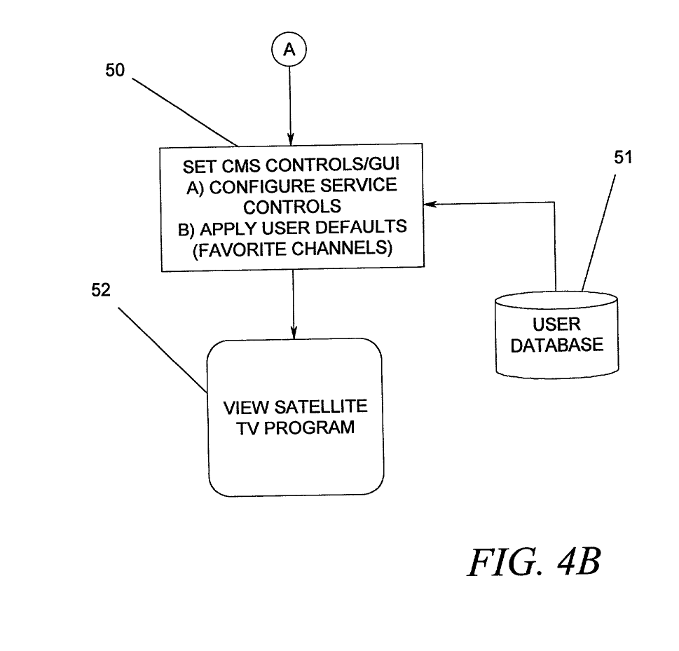

Referring now to FIG. 4A, the first of a two-sheet flow chart illustrates the Initialization process of the present invention. The process begins with a boot up step (bubble 40). Next, a query is made as to whether the services (RDU's) are installed and configured (block 41). After this, navigational data is retrieved from the AIU 22 (block 42), which step is periodically performed. Following this, an inquiry is made as to whether or not the system is within a valid service region (diamond 43). If the answer to this inquiry is no, then a No Service signal is sent to notify the Cabin Management System (“CMS”) and the Passenger Flight Information System (“PFIS”), such as the Airshow video program manufactured and sold by the assignee hereof (block 44). The CMS includes signal switching/distribution/control equipment. A flag is displayed or a display is made that anunciates a message (i.e., “ANNUNCIATOR”) on the CMS (block 45) and Time to Live Television (“TTTV”) is displayed on the PFIS (block 46).

At the same time that the “No Service” notification is sent out (block 44) a return is made to the block 42 for retrieval of navigational data from the AIU 22. If the answer to the inquiry in the diamond 43 is yes, then an “In-Service” notification is set up for acquiring the satellite (block 47). The DAU 22 points the antenna 20 to the acquired satellite using a servo loop and the AIU 22 is configured for the acquired satellite. Satellite acquisition parameters are retrieved from a service database 48. Following the above, the audio, video, data signal is configured to initiate service in the RDU's 29, 30; service is applied Conditional Access (“CA”); and, the change is stated to the CMS (block 49). CA is a SmartCard protocol utilized by direct broadcast satellite service to control access to paying customers. The process description continues hereinbelow with reference to FIG. 4B as denoted by a connector A.

Referring now to FIG. 4B at the connector A, the CMS controls/GUI are set (block 50). This step refers to the fact that the CMS can configure itself to display an appropriate GUI based on the system. It is pointed out that the transceiver functions can change, depending on the selected satellite service (Galaxy Latin America GUI for Mexico may have programs listed in Spanish, for example). That is, the service controls are configured and user defaults (i.e., favorite channels) are applied. Access is made by this step to a user database 51 for such user defaults. After this, the satellite TV program is displayed (screen 52).

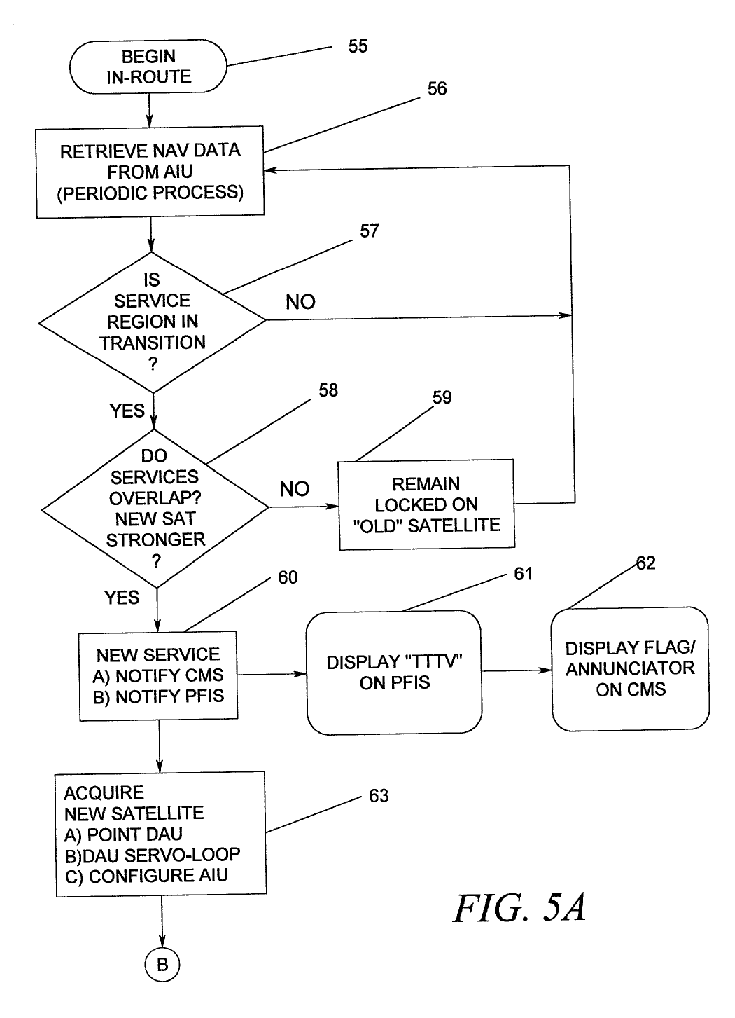

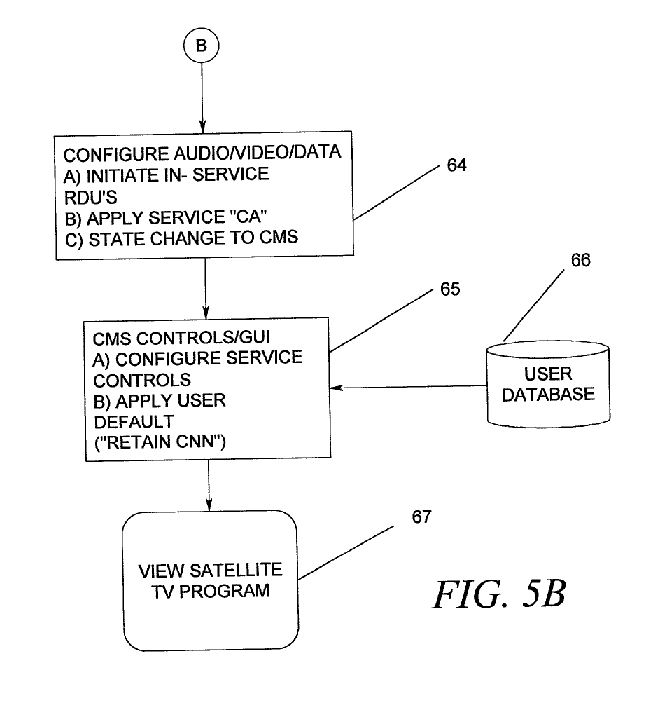

Referring now to FIG. 5A, the process for In-Route Control is shown in a flow chart form. The process begins with a Begin In-Route step (bubble 55). Next, navigational data is retrieved from the AIU 22 on a periodic basis (block 56). After this, an inquiry is made as to whether or not the service region is in transition (diamond 57), which would occur in the situation depicted in FIG. 1 (across the US/Mexico border). If the answer to this inquiry is no, then a return is made back to the step depicted by the block 56 for retrieval of navigational data. On the other hand, if the answer is yes, then another inquiry is made as to whether or not the services overlap and if the new satellite stronger (diamond 58). If the answer to this inquiry is no, then the system remains locked onto the “old” or current satellite (block 59) and a return is made back to the block 56 for retrieval of navigational data.

If the answer to the inquiry depicted by the diamond 58 is yes, then a notification of the new service is issued by notifying the CMS and the PFIS (block 60). From this step, a display is made of the Time to Live TV (“TTTV”) on the PFIS (screen 61) and a flag/annunciator is displayed on the CMS (screen 62). At the same time, once the new satellite is acquired the DAU 21 points the antenna 20 to this new satellite and corrects by using a servo loop. The AIU 22 is also configured for the new satellite at this time. The process description continues hereinbelow in conjunction with the next sheet of the drawings as denoted by a connector B.

Referring now to FIG. 5B at the connector B, the audio/video/data signals are configured and the in-service RDU's 29, 30 are initiated; service “CA” is applied; and, state is changed to CMS (block 65). Access is made to a user database 66 for performing the step depicted by the block 65. Finally, the satellite TV program is displayed (screen 67).

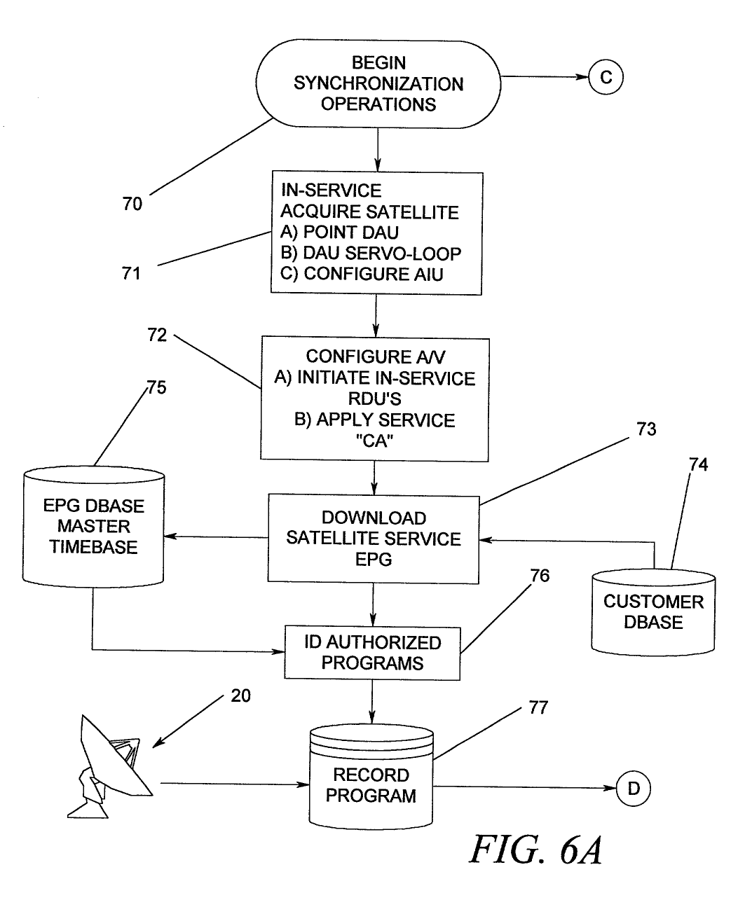

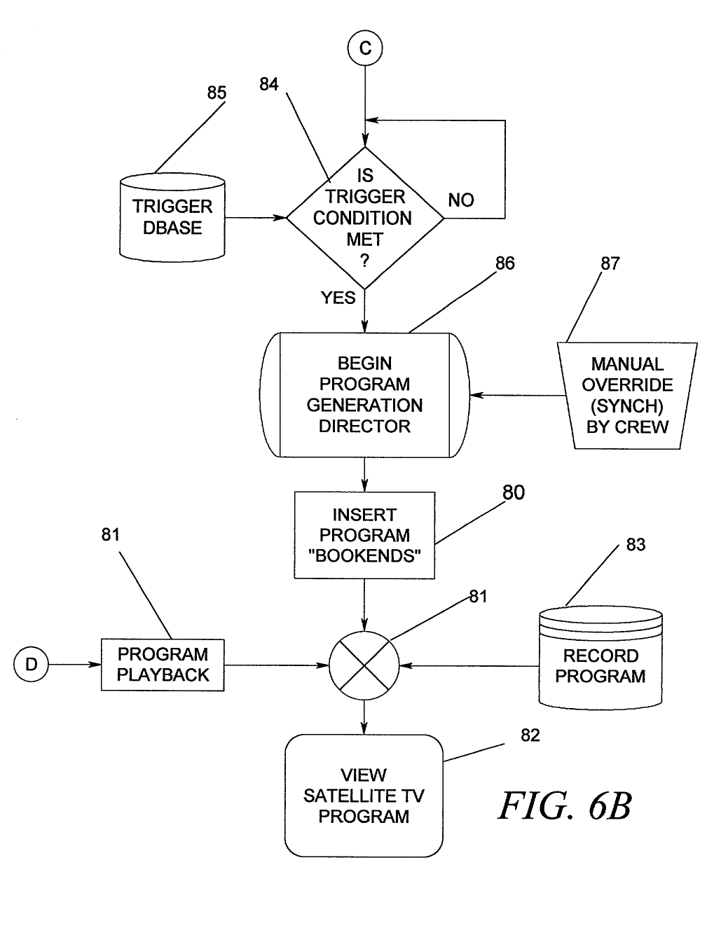

Referring now to FIG. 6A, a first of a two-sheet flow chart illustrates the process for Synchronization Operations. The process begins with a start bubble 70 followed by a step of acquiring an in-service satellite (block 71), which includes pointing the antenna 20 with the DAU 21 and using the DAU servo-loop. The AIU 22 is also configured for the newly acquired satellite.

After this, the appropriate RDU is selected, the CA applied to decode the program material (block 72) and the satellite EPG (Electronic Program Guide) is downloaded from the satellite (block 73). A customer data base 74 contains information about programs to be used on board the aircraft. It acts as a filter to select certain ones of the many programs available on the EPG. The EPG master time base 75 is also accessed from the satellite and stored (real-time periodic) for later use by the system. Following this, identification of authorized programs is made (block 76) and the program received by the antenna 20 is recorded on storage medium 77. The process description continues hereinbelow in conjunction with the next sheet of the drawings as denoted by a connector D.

Referring now to FIG. 6B at the connector D, programs are played back (block 80) and applied to a mixer 81 for display on a screen 82. Recorded programs 83 may also be selected at the mixer for display on the screen 82. Returning back to the start bubble 70 in FIG. 6A, the begin synchronization operations also connect to that part of the process illustrated in FIG. 6B by a connector C.

Another advantage of the present invention is the application of event triggers to automatically record program material off the satellite audio, video, and data signals, and to synchronize the playback thereof using the time base down-loaded from the satellite.

An inquiry is made as to whether or not a trigger condition has been met (diamond 84). Trigger conditions are customer defined. The application of event triggers may be used to automatically record program material off the satellite audio, video, and data signals, and to synchronize the playback thereof using the time base down-loaded from the satellite. Triggers include definitions such as Phase-of-Flight, Elapsed Time, and Pre-programmed Playback Time matched to the EPG master time data base 75. If the inquiry receives a positive response (i.e., yes answer from the diamond 84), the system notifies a Program Director application (block 86), which is generally resident with the recorded media unit, to begin the process of playing back the recorded programs. A manual override (or synch) (block 87) may also be made available to the crew as a back-up mechanism to launch the Program Director. Next, program “bookends”, comprising branding, advertisements, introductory footage, etc., are inserted (block 80) into the mixer process, generally at the beginning and end of defined program segments. The resulting composite program is distributed to display services throughout the aircraft.

While the invention has been particularly shown and described with reference to a preferred embodiment, it will be understood by those skilled in the art that various changes in form and detail may be made therein without departing from the spirit and scope of the invention.

Those skilled in the art will appreciate that various adaptations and modifications of the just-described preferred embodiments can be configured without departing from the scope and spirit of the invention. Therefore, it is to be understood that within the scope of the appended claims, the invention may be practiced other than as specifically described herein.

What is claimed is:

1. A system for tracking and transceiving intelligence bearing signals from satellites for distribution to a multiplicity of devices on an aircraft, and for automatically switching between different first and second satellites while the aircraft is in route, said system comprising:
a. a first unit responsive to navigational data from systems of said aircraft for determining if a service region of said first satellite is in transition;
b. said first unit also capable of determining if satellite service overlaps with a second satellite, and if said second satellite signal is stronger;
c. a second unit responsive to signals from said first unit for acquiring service from said second satellite by pointing said antenna to said second satellite; and,
d. a third unit for configuring second intelligence signals transceived from said second satellite for displaying and distributing said configured second intelligence signals transceived from said second satellite to devices within said aircraft.

2. The system according to claim 1 further including a unit responsive to said navigational data for determining the right to transceive said intelligence bearing signals within various geographical regions by applying regulatory criteria from a database containing such information.

3. The system according to claim 1 further including a database storing event triggers for automatically recording program material off the satellite audio, video and data signals.

4. The system according to claim 1 further including a database storing event triggers for automatically synchronize playing back program material recorded off the satellite audio, video and data signals using a time base recorded from said satellite.

5. The system according to claim 1 further including a database containing satellite program guides for identifying a desired satellite to track and transceive information therefrom.

6. The system according to claim 1 further including a unit enabling the receipt of communication from a passenger for transmission to a ground station via a satellite.

7. The system according to claim 1 further including a unit responsive to a passenger making selections of content material for display.

8. In a system having an antenna for tracking and receiving intelligence bearing signals from satellites for distribution to a multiplicity of devices on an aircraft, a method for automatically switching between different satellites while the aircraft is in route, said method comprising:
a. retrieving navigational data from systems of said aircraft;
b. determining if a service region of said first satellite is in transition, and if so;
c. determining if satellite service overlaps with a second satellite, and if said second satellite signal is stronger, and if yes;
d. acquiring service from said second satellite by pointing said antenna to said second satellite;
e. configuring second intelligence signals received from said second satellite; and,
f. displaying and distributing said configured second intelligence signals received from said second satellite to devices within said aircraft.

9. The method as in claim 8 wherein it is determined that said second satellite signal is not stronger, remaining locked onto said first satellite and repeating all the steps of claim 8.

10. The method as in claim 8 wherein it is determined that the service region of said first satellite is not in transition, further including the step of retrieving navigational data from systems of said aircraft.

11. The method as in claim 8 wherein it is determined that satellite service overlaps with a second satellite and said second satellite signal is stronger, further including the step of displaying a notification to said devices within said aircraft that new intelligence signals will soon be received.

12. The method as in claim 8 further including the step of determining, in response to navigational data of said aircraft, the right to transceive said intelligence bearing signals within various geographical regions by applying regulatory criteria from a database containing such information.

13. The method as in claim 8 further including storing in a database event triggers for automatically recording program material off the satellite audio, video and data signals.

14. The method as in claim 8 further including storing in a database event triggers for automatically synchronizing playing back program material recorded off the satellite audio, video and data signals using a time base recorded from said satellite.

15. A storage medium encoded with machine-readable computer program code for use in a computer controlled satellite tracking system on board a passenger aircraft for receiving intelligence bearing signals from satellites for distribution to a multiplicity of devices on an aircraft and for automatically switching between different satellites while the aircraft is in route, wherein, when the computer program code is executed by said system, the system performs the steps of:
a. retrieving navigational data from systems of said aircraft;
b. determining if a service region of said first satellite is in transition, and if so;
c. determining if satellite service overlaps with a second satellite, and if said second satellite signal is stronger, and if yes;
d. acquiring service from said second satellite by pointing said antenna to said second satellite;
e. configuring second intelligence signals received from said second satellite; and,
f. displaying and distributing said configured second intelligence signals received from said second satellite to devices within said aircraft.

16. The storage medium as in claim 15 wherein it is determined that said second satellite signal is not stronger, remaining locked onto said first satellite and repeating all the steps of claim 15.

17. The storage medium as in claim 15 wherein it is determined that the service region of said first satellite is not in transition, further including the step of retrieving navigational data from systems of said aircraft.

18. The storage medium as in claim 15 wherein it is determined that satellite service overlaps with a second satellite and said second satellite signal is stronger, further including the step of displaying a notification to said devices within said aircraft that new intelligence signals will soon be received.

19. The storage medium as in claim 15 further including the step of determining, in response to navigational data of said aircraft, the right to transceive said intelligence bearing signals within various geographical regions by applying regulatory criteria from a database containing such information.

20. The storage medium as in claim 15 further including storing in a database event triggers for automatically recording program material off the satellite audio, video and data signals.

21. The storage medium as in claim 15 further including storing in a database event triggers for automatically synchronizing playing back program material recorded off the satellite audio, video and data signals using a time base recorded from said satellite.
